(19) United States
(12) Patent Application Publication
(10) Pub. No.: US 2012/0244944 A1
(43) Pub. Date: Sep. 27, 2012

(54) Game Controller Accessory

(76) Inventor: DAVID KOTKIN, MIAMI, FL (US)

(21) Appl. No.: 13/421,395

(22) Filed: Mar. 15, 2012

Related U.S. Application Data
(63) Continuation-in-part of application No. 12/782,089, filed on May 18, 2010.
(60) Provisional application No. 61/452,902, filed on Mar. 15, 2011.
(60) Provisional application No. 61/179,551, filed on May 19, 2009.
(60) Provisional application No. 61/306,211, filed on Feb. 19, 2010.

(51) Int. Cl. A63F 13/06

(52) U.S. Cl. 463/38; 463/37

(57) ABSTRACT

A game controller accessory is provided herein, which interacts with existing game controller buttons and/or actuators to provide novel mechanisms for activating those buttons and/or actuators.

### CROSS-REFERENCE TO RELATED APPLICATIONS

The present application claims priority from co-pending Provisional Patent Application No. 61/452,902, filed on Mar. 15, 2011 and entitled “GAME CONTROLLER ACCESSORY”, and is a continuation-in-part of co-pending U.S. patent application Ser. No. 12/782,089, filed on May 18, 2010, entitled “DEVICE FOR ENHANCING OPERATION OF A GAME CONTROLLER AND METHOD OF USING THE SAME”, which claimed priority from Provisional Patent Application No. 61/179,551, filed on May 19, 2009 and 61/306,211, filed on Feb. 19, 2010; all of the foregoing applications being incorporated herein, by reference, in their entireties.

### BACKGROUND OF THE INVENTION

1. Field of the Invention

The present invention relates to a game controller accessory, and more particularly, to a game controller accessory that can be used with existing game controllers to more easily facilitate actuation of the various game controller buttons and interfaces.

2. Description of the Related Art

A joystick adapter for a directional keypad on a game controller is provided in U.S. Pat. No. 5,883,690 (the '690 patent). The joystick adapter of the '690 patent is provided for mounting over the depressible buttons of a directional keypad on a video game controller in order to convert manually depressible keys to a joystick controller that is manipulated by the user's thumb. See, for example, col. 4 of the '690 patent, lines 14-20.

A key-operating device for a hand-held video game apparatus is illustrated in U.S. Pat. No. 6,933,861 to Wang (the '861 patent). The '861 patent discloses a key operating device, to which the hand-held video game apparatus is mounted thereon. See, for example, col. 2 of the '861 patent, lines 56-59.

What is needed is a game controller accessory that provides other configurations of use and other mechanisms for actuating buttons on existing game controllers.

### SUMMARY OF THE INVENTION

A game controller accessory is provided herein, which interacts with existing game controller buttons and/or actuators to provide novel mechanisms for activating those buttons and/or actuators.

Other features which are considered as characteristic for the invention are set forth in the drawings and the appended claim.

Although the invention is illustrated and described herein as embodied in a game controller accessory, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

For a fuller understanding of the nature of the present invention, reference should be made to the following detailed description, taken in connection with the accompanying drawings in which:

FIG. 1 is a perspective view of an accessory for a game controller, in accordance with one particular embodiment of the invention;

FIG. 2 is a perspective view of an accessory for a game controller, having a game controller received therein, but wherein the accessory is open, in accordance with one particular embodiment of the invention;

FIG. 3 is a perspective view of an accessory for a game controller, the portions of which are closed around the game controller received therein, in accordance with one particular embodiment of the invention;

FIG. 4 is a bottom view of an accessory for a game controller, the portions of which are closed around the game controller received therein, in accordance with one particular embodiment of the invention;

FIGS. 5A-5B are side perspective views of an accessory for a game controller having a game controller received therein, in accordance with another particular embodiment of the invention;

FIGS. 6A-6B are side perspective views of an accessory for a game controller having a game controller received therein, in accordance with a further particular embodiment of the invention;

FIG. 7 is a front plan view of an accessory for a game controller having a game controller received therein, in accordance with one particular embodiment of the present invention;

FIG. 8 is a side perspective view of an accessory for a game controller having a game controller received therein, in accordance with another particular embodiment of the invention;

FIG. 8A is an enlarged view of a portion of the accessory and game controller of FIG. 8;

FIGS. 9A, 9B, 9C and 10 illustrate certain different embodiments of an accessory for a game controller and game controller, wherein a control loop is provided;

FIGS. 11A-11C and 15-16 illustrate detachable or retrofit control loops for use with a game controller in accordance with certain embodiments of the present invention;

FIGS. 12 and 13 show a control loop carrying advertising in accordance with one particular embodiment of the invention;

FIG. 14 shows a portion of a game controller including a stick accessory in accordance with one particular embodiment of the invention;

FIGS. 17 and 18 show two views of a game controller including a foot control strap or loop, in accordance with a further embodiment of the invention; and

FIG. 19 shows an alternate gearing arrangement for use with a gaming accessory, in accordance with another particular embodiment of the present invention.

### DETAILED DESCRIPTION OF THE PREFERRED EMBODIMENT

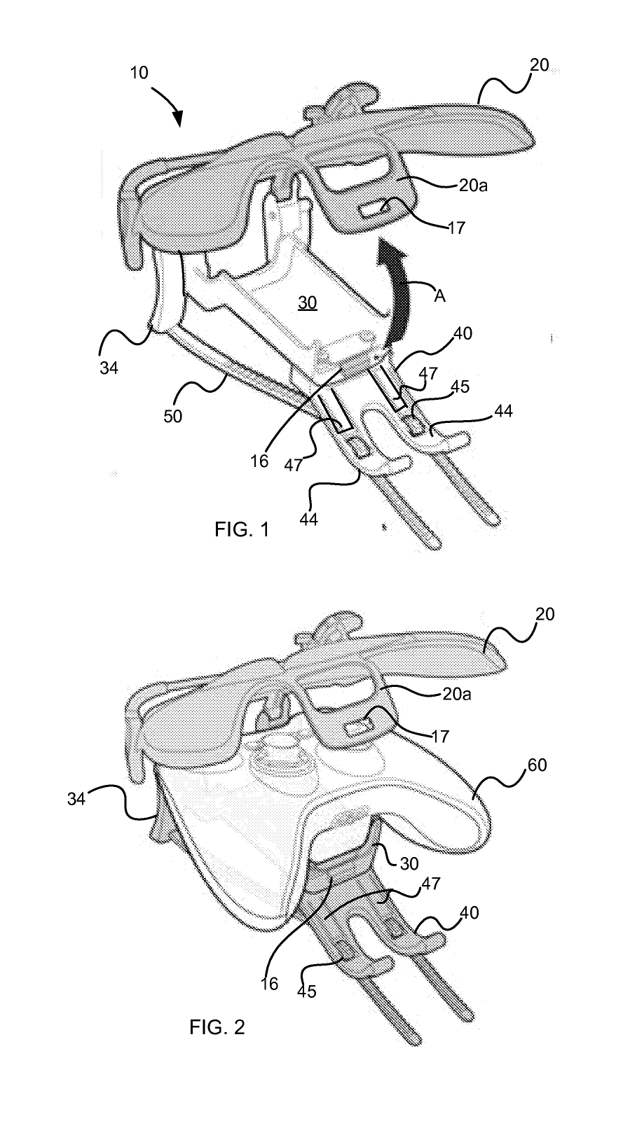

Referring now to FIGS. 1-4, there is shown a game controller skin or shell 10 including a top portion 20, a bottom portion 30 and a stand 40. In the present embodiment, the top portion 20 and bottom portion 30 are hinged together at one end, so as to receive a game controller 60, therebetween (i.e., within a clam shell configuration formed by the top portion 20 and bottom portion 30). A free end 20a of the top portion 20 can swing away from the free end of the bottom portion 30, in the direction of arrow “A”, in order to open the shell 10 to receive or remove the game controller 60.

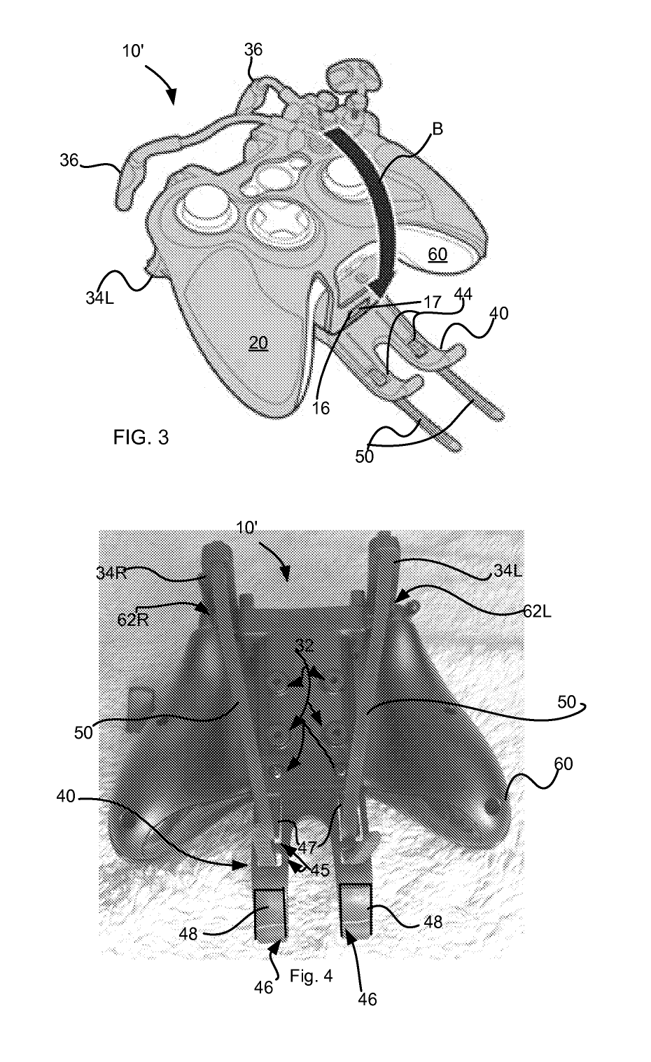

The shell 10 can then be closed by moving the free end 20a of the top portion 20 towards the bottom portion 30, in the direction of arrow “B”, to engage a button 16 on one portion 20, 30, with a hole or catch 17 on the other portion 20, 30, in order to latch or secure the shell 10 in the closed position, thus forming the game controller and shell combination 10′, when the game controller 60 is received inside of the shell 10. The latching of the top and bottom portions 12, 14 around the game controller 60 additionally ensures that the actuable portions of the game controller (i.e., buttons, joysticks, controllers, etc.) are maintained in their desired positions relative to the corresponding portions of the shell 10, as shown more particularly in FIG. 3. The shell 10 can be in accordance with those described in U.S. Patent Application Publication No. 2010/0298053, which is the publication of U.S. patent application Ser. No. 12/782,089, from which application the present application claims priority, that application being incorporated herein, by reference.

In one particular embodiment, the stand 40 is an add-on flexible and/or rocker stand that can be removably engaged from the game controller skin 10. As shown more particularly in the embodiment of FIG. 4, the stand 40 is designed to engage one or more adaptor hole pairs 32 on the game controller shell 10 that is overlaid on a game controller 60. In another embodiment, the stand 40 can be used to engage one or more adaptor hole pairs provided in a game controller, itself. The flexible stand 40 is like a rocking chair for the controller 60. In use, when standing up, laying down or sitting, the tips of the rocker stand 40 are arranged to rest on the abdomen of a user, ideally, right bellow the navel. If the user is lying on his or her stomach, the stand permits the game controller and shell combination 10′ to be used sniper-like, wherein the stand 40 can rest on the ground in front of the user to simulate a tripod. The rocker stand 40, thus, provides steadiness, while the hands and wrist no longer have to support any weight from the controller 60. It is unobtrusive enough that the user could use it during play when tired, or when needing that steady shot. On car trips it would also be most valuable. Additionally, if used in the sitting position, for example when on a recumbent bicycle, the stand can be used to steady/balance the controller/shell combination 10′ on the abdomen of the user, and can be used to absorb the shock of pedaling.

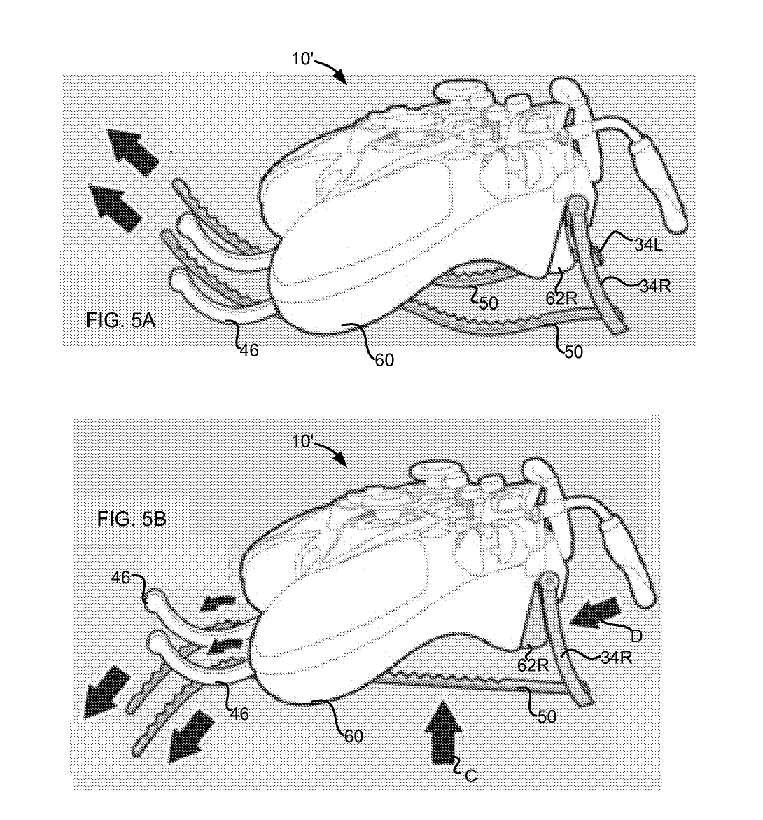

As shown in FIGS. 1-5B, the stand 40 can additionally be engaged with one or more trigger levers 34 on the skin of the controller. For example, the controller skin 10 of the present embodiment overlays a controller having right and left end buttons (62R and 62L, respectively). The controller skin 10 includes the end button trigger levers 34R and 34L aligned with the end buttons 62R and 62L on the controller 60. An adjustable tension strap 50 extends from each end button trigger lever 34R, 34L to a pair of closely set holes 45 in each leg 46. More particularly, a first end of the strap 50 is pulled or threaded through the first hole of the pair 45 in each leg 46 of the stand 40 (see FIG. 5A). A tongue or leaf spring 47 in each leg 46 of the stand 40, adjacent to the first hole, engages one of a plurality of projections on each adjustable tension strap 50. The first end of the strap 50 is further threaded through the second hole of the pair 45, to secure the strap to the leg 46 of the stand 40 (See, for example, FIG. 4 and FIG. 5B), much like going through a belt buckle. Thus, the stand 40 is designed for comfort, but also provides the function of holding the straps 50 (see, the tuck in of the straps in the FIGS. 4 and 5B), and the slitted leaf springs 47 allow the straps 50 to be retained by engaging a projection on the strap 50.

The length of each respective adjustable tension straps 50 can be adjusted, as desired, to apply a desired amount of tension on its respective end button trigger lever, 34R, 34L. In one particular embodiment of the invention, the straps 50 are tightened until the end button 62R, 62L activates, and then the strap is loosened by one notch (i.e., one projection is fed back through the first hole). When the combination 10′ is held in the hand of the user, the end button trigger levers 34R, 34L may be actuated by either pressing a leg 46 or legs 46 of the stand 40 against the floor or body of the user, or by squeezing the adjustable tension strap(s) 50 towards the body of the controller 60, thus actuating the respective end button trigger lever(s) 62R, 62L, without actually having to touch the end button trigger lever(s) 34R, 34L.

As can be appreciated, applying a force to one of the adjustable tension straps 50 in the direction of arrow “C”, even a light force, results in a relative force being applied in the direction of arrow “D” to the respective trigger lever 34R, 34L. Additionally, the straps 50 keep the levers 34R, 34L pressed against the end buttons 62R, 62L, or “preloaded”, just above the activation point, so as to require less button movement/travel when repeatedly actuating the end buttons 62R, 62L by applying a force to the levers 34R, 34L in the direction of arrow “D”. This permits the user to quickly activate the end buttons to rapidly fire and/or quickly zoom with the lightest touch.

If desired, the tips of the legs 46 of the flexible rocker stand can be coated with, or otherwise provided with, a non-skid or anti-skid coating material 48, as shown in FIG. 4. Alternately, if desired, the ends of the legs 46 can be covered with a foam or other material for comfort and/or non-skid purposes. Similarly, if desired, different materials could also be provided on the levers 36 and/or other actuators on the game controller skin. For example, a rubber could be added that acts like a spring to store potential energy and pop the x y b button click. Such a material also follows the user's fingers more. It mimics the user's fingers to feel the click stronger, and is reminiscent of bouncing a ball in that it does a lot with just one drop. The bounce does a lot. So this could be changed for a game with a lot of button mashing like street fighter.

Additionally if desired, a very stretchy line can be used to replace part or all of the adjustable tension strap 50 to either or both of the trigger levers 34R, 34L. The tension in this new line can be adjusted. In use, the fingers do not touch the line shown in FIG. 3A, in any way, they only touch the trigger lever 34L, which actuates the trigger button 62L. By adjusting the tension on the line, the player can adjust the tension on his triggers (i.e., by adjusting the bias on the trigger levers) making them more sensitive. They are now real hair triggers.

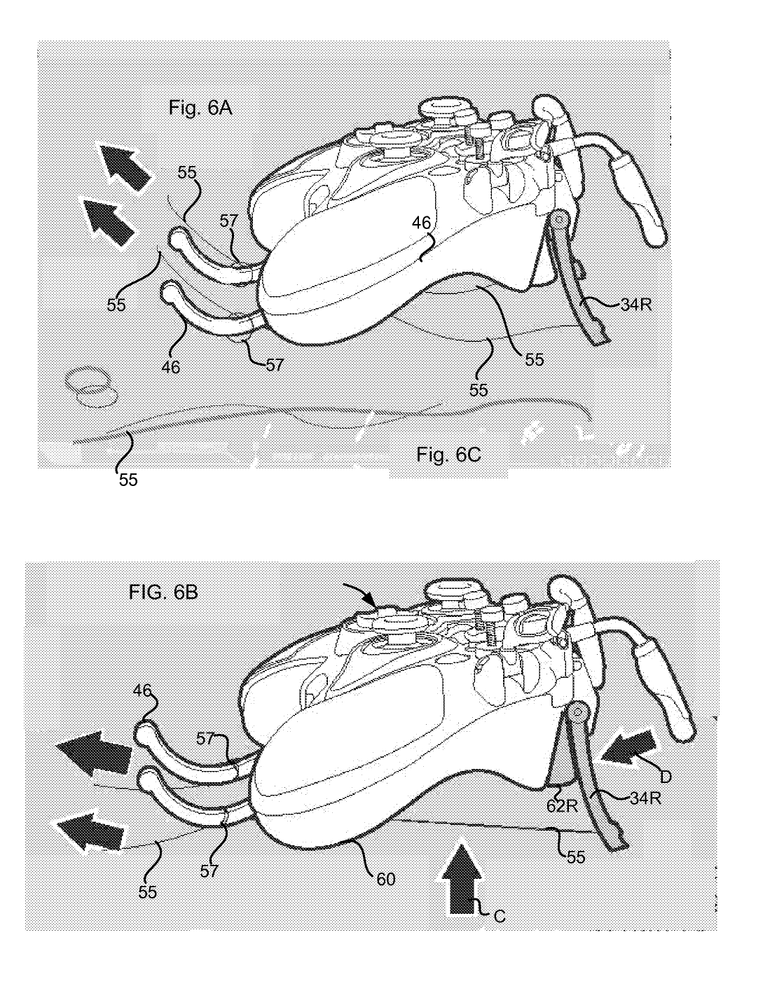

Referring now to FIGS. 6A-6C, there is shown another embodiment of the game controller and shell combination wherein the adjustable straps (50 of FIG. 4) are replaced by very flexible, elastic lines or stretch straps 55. The elastic lines 55 have more give or stretch than the straps 50 of FIGS. 1-4. This creates more bounce, when actuating the levers 34R, 34L. For example, think of a basketball bouncing/rebounding very quickly when dribbled from very close to the floor. In a similar way, the elastic lines 55 can be used to trigger a “bounce” of the lever 34R, 34L so that the right and left end buttons 62R, 62L can be rapidly and repetitively actuated with very little effort. For example, if one or both of the end buttons are used as gun triggers in gameplay, the elastic line 55 gives the triggers a bounce, so that the user can fire faster with less effort. Similarly, one of the elastic lines 55 can be used to quickly zoom in and/or out in a game that uses the end button 62R, 62L for zooming. Additionally, the elastic line 55, when pulled taut, as shown in FIG. 6B, makes the trigger float closer to the firing point. It gives the user even more of a hair trigger. In one particular embodiment of the present invention, the elastic line 55 is looped around each leg 46 in a loop 57 and pulled tight.

In one particular embodiment, in order to set the hair trigger the elastic lines are tightened until the trigger activates, then are slightly loosened. The triggers are then used as normal (i.e., pressing the levers 34R, 34L, in the direction of arrow “D”). This permits the user to, in our examples, rapidly fire and quickly zoom with the lightest touch, as the constant tension on the levers 34R, 34L, caused by the elastic lines 55, preload the levers 34R, 34L at the position just before actuation of the buttons 62R, 62L. This results in less trigger travel being required to actuate the buttons, as well as acts as a shock absorber for the levers, providing smoothness of actuation without sticking in the actuated position.

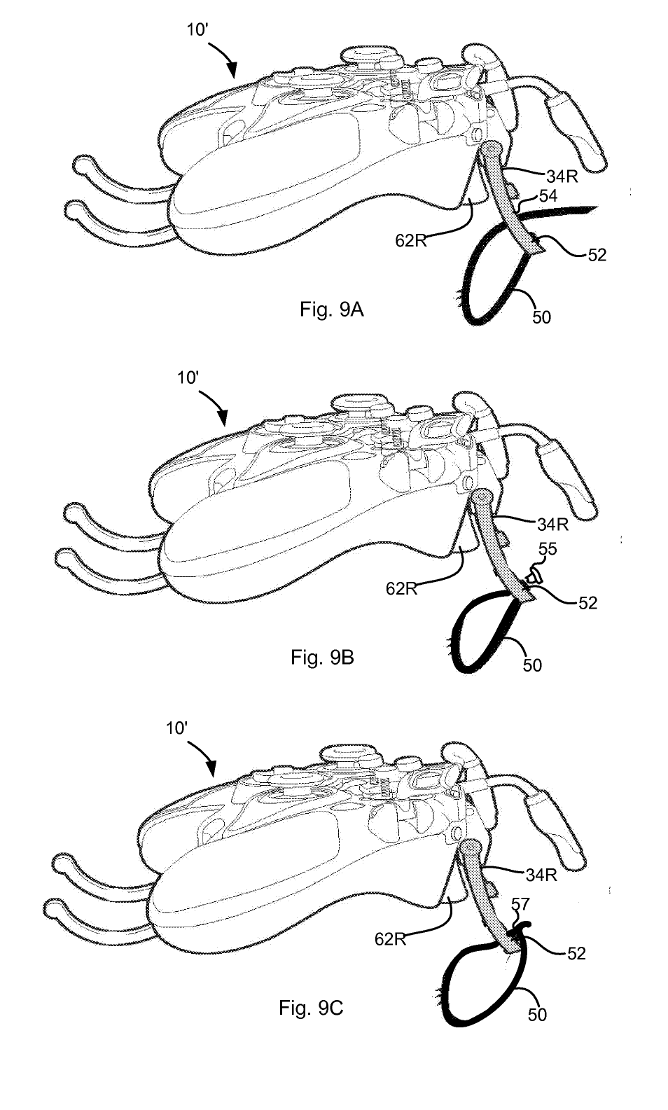

Additionally, if desired, the adjustable tension straps 50 or elastic lines 55 connected to the trigger levers 34R, 34L of FIGS. 1-6B, need not extend all the way from the trigger levers 34R, 34L to the stand 40. Referring now to FIGS. 9A-9C, there are shown other particular embodiments of the invention wherein the tension straps are released from the stand to form loops that can be used to actuate the trigger levers 34R, 34L, if desired.

More particularly, if desired, each of the trigger levers 34R, 34L can be provided with one or more holes for receiving one or both ends of the adjustable tension strap 50, as shown in FIGS. 9A-9C. At least a first hole 52 is provided to receive the adjustable tension strap for that lever 34R, 34L. If it is desired that one or more of the provided adjustable tension straps 50 should not be connected to the stand 40, then that respective strap 50 can be disconnected from the receiving hole in the stand 40 and looped back (with the projections on the outside, for comfort) into the first hole 52 in the trigger lever 34R, 34L, as shown in FIG. 9B, thus creating a loop or control loop. A plug 55 can be provided to retain the two ends of the strap 50 in the hole 52. Alternately, a strap 50 can be disconnected from the receiving hole in the stand 40 and looped back into an optional second hole 54 in the trigger lever 34R, 34L, as shown in FIG. 9A. If desired, the second distal end of the adjustable tension strap 50 can bypass a hole altogether, and be fastened with a fastener or band 57 or in some other fashion to the back end of the first end of the adjustable tension strap 50 to form the loop, as shown more particularly in FIG. 9C. Such a loop can be pulled by a finger or hand of the user to actuate the respective trigger lever 34R, 34L.

The use of such a “loop” or “control loop”, as described herein, makes the control of the trigger lever(s) more secure and easier to use, because of leverage. It additionally provides a reaction time based advantage, since it requires just a squeeze to actuate the lever. Further, the loop is easier to use to hold the trigger down for long periods.

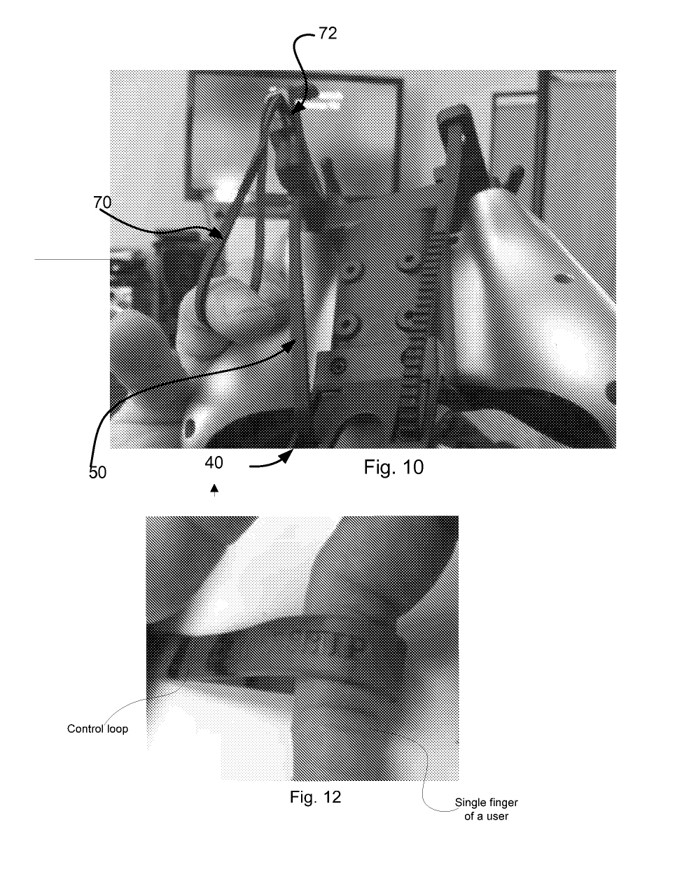

In an even further embodiment shown in FIG. 10, a trigger lever extension 72 is provided wherein at least one hole is provided on an extension to the trigger lever 34L, 34R. More particularly, the trigger lever extension 72 can be an add-on part that is releasably engaged to an end of one or more of the trigger levers 34R, 34L, for example, by snapping or clipping onto an end of the trigger lever “R” and/or “L”. Alternately, one or more of the trigger levers 34R, 34L can be formed to include the trigger lever extension 72, if desired. Such a design maintains the adjustable tension strap line between the trigger lever 34R and/or 34L and a respective leg of the stand 40, while still providing a control loop 70 as an alternate way to control the actuation of the trigger lever 34R and/or 34L. The adjustable tension strap 50 to the stand 40 can be adjusted to take out the preload when using the control loop 70 (i.e., as an anchor). The trigger extension 72 would make the trigger lever 34R, 34L approximately one inch longer than without the extension 72. As described in connection with FIGS. 9A-9C, the loop 70 can be used around one of the user's fingers to control a respective trigger lever 34R, 34L, or the adjustable tension strap 50 to the stand 40 can be used.

If made as an add-on accessory, the trigger extension 72 would clip and/or stick to the trigger lever 34R, 34L and would come with the adjustable control loop 70. In one particular embodiment of the invention, the control loop 70 of the present embodiment has the advantage that the loop does not touch any of the user's fingers other than the one used in the loop 70, thus freeing up the other fingers for use elsewhere on the controller. The adjustable tension strap(s) 50 is/are used to adjust the preload on the trigger lever 34R, 34L when controlled by the control loop 70. The use of the control loop 70, anchored by the adjustable tension strap 50 to the stand 40, provides additional leverage for actuating the trigger lever 34R, 34L, making it much easier to pull.

Note that, although thin straps are shown for the loop or control loop in the foregoing embodiments, this is not meant to be limiting, as wider straps of various materials may be used.

Referring now to FIGS. 11A-11C, it can be seen that the control loops 78 can be provided as separate parts that can be adhered by a connecting portion 76 (using adhesive, hook and loop fasteners, etc) directly to the trigger buttons “R” and “L”, or other buttons, of a game controller.

Additionally, as shown more particular in FIG. 11C, the control loop 78 of the present embodiment can be attached to a leg of a stand or pedestal base of the controller and be used as described hereinabove in connection with the adjustable tension straps 50 and/or elastic line 55. More particularly, the “R” and “L” buttons can be controlled by pressing the control loop 78, so connected, against the body of the game controller with a palm, or with fingers, as shown in FIG. 11C.

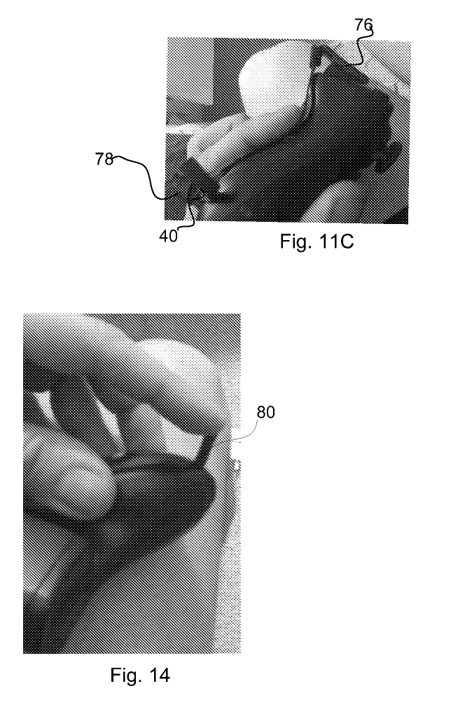

Note that, if desired, the retrofit control loop assembly (76, 78) can be provided as part of a kit. For example, such a kit could be provided with a stick 80 that fits in the back, as shown more particularly in FIG. 14. Most controllers have a hole at this location in which to put a screw. It is not necessary (or desired) to remove that screw. Rather, the stick 80 can be placed and a line can be attached to the back, as shown more particularly in FIG. 11C. In such a case, as described above, when the line is pressed, the trigger is moved and, thus, actuated. Such a line can be made from any type of material, as desired, but is preferably made from an elastic material. As shown more particularly in FIG. 11B, the line can also be turned into hoop.

Such a kit can be sold for a fixed price, and including one or more control line assemblies. In one particular embodiment of the invention, the kit includes a line wrapped up with pedal cover with hard wax. It stays in place, but can be peeled of easily with no damage to the underlying game controller.

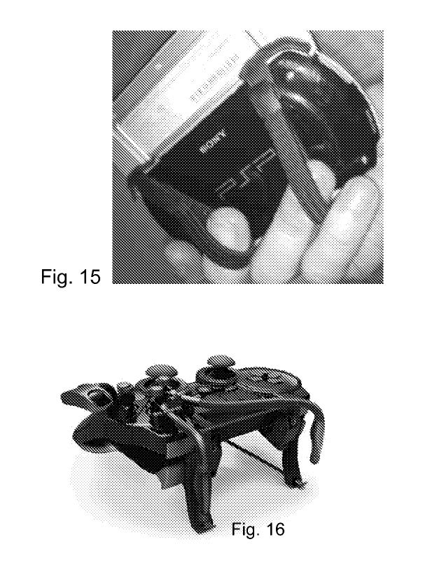

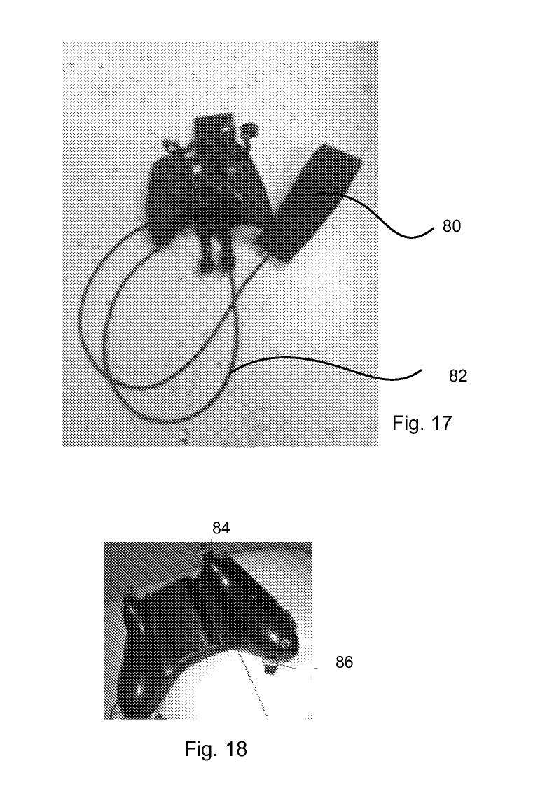

Such a system can be used with a variety of controllers, as illustrated more particularly in FIGS. 15 and 16. For example, the retrofit stick-on loop controller, as shown in FIGS. 11A-11C, could be adapted for the Sony PSP or Nintendo DSi, Sony Playstation 3, Microsoft XBOX, etc.

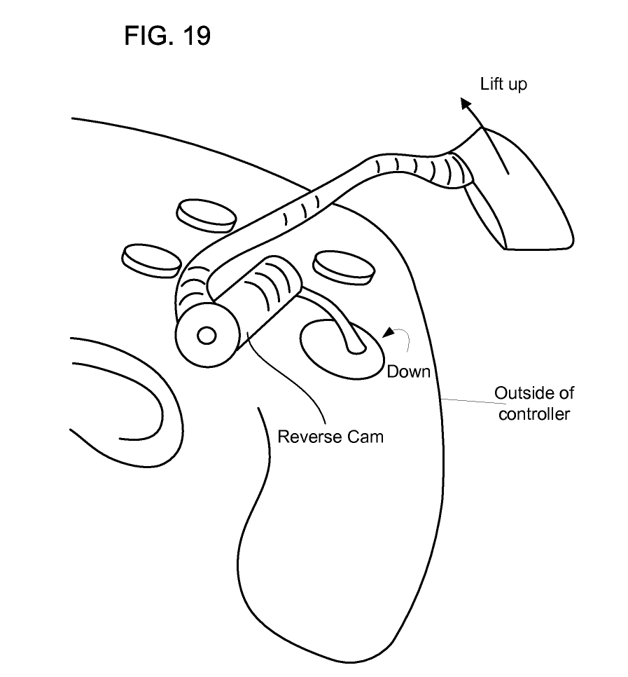

In a further embodiment of the invention shown in connection with FIGS. 18-19, a stick-on retrofit foot strap can be provided that works as an accelerator (i.e., a gas pedal, etc.). More particularly, a trigger line 82 is provided that goes from the strap or loop 80, to one or more buttons on the controller (such as the “R” and “L” buttons), to the foot of the user. Alternately, it could be provided to another distal location on the user, such as, for example, to the belt loop of the user. In particular, a line goes to the user's foot and is operated by stretching the line 82, for example, by pointing the toe of the user, to move the trigger. It can also be a slight lift, such as, like an old fashioned treadle sewing machine that works with a foot switch. The foot strap controller is very useful to physically challenged users.

The foot control loop 80 can actuate the triggers in a variety of ways. For example, the foot control loop line can be connected to the trigger by sticking on, such as by a connecting portion 84, such as, with adhesive or with a hook-and-loop fastener.

Additionally, if desired, bumpers 86 can be provided such that, through an attachment of stick-ons and stretchy line, the user can adjust the force it takes to engage bumpers and triggers. Think of mountain climbing. It can make it so the slightest touch engages a trigger. This is good for overuse injuries and faster game play So that the person using this system has an advantage. Additionally, the bumpers can be adjusted by the user, as desired.

Alternately, the line to the foot control loop can be connected to the freed, stand-end of the adjustable tension straps 50 of the embodiment of FIGS. 1-5B by clamping, connecting, or otherwise tying the line 82 to the free end of the strap 50, distal from the lever 34R, 34L.

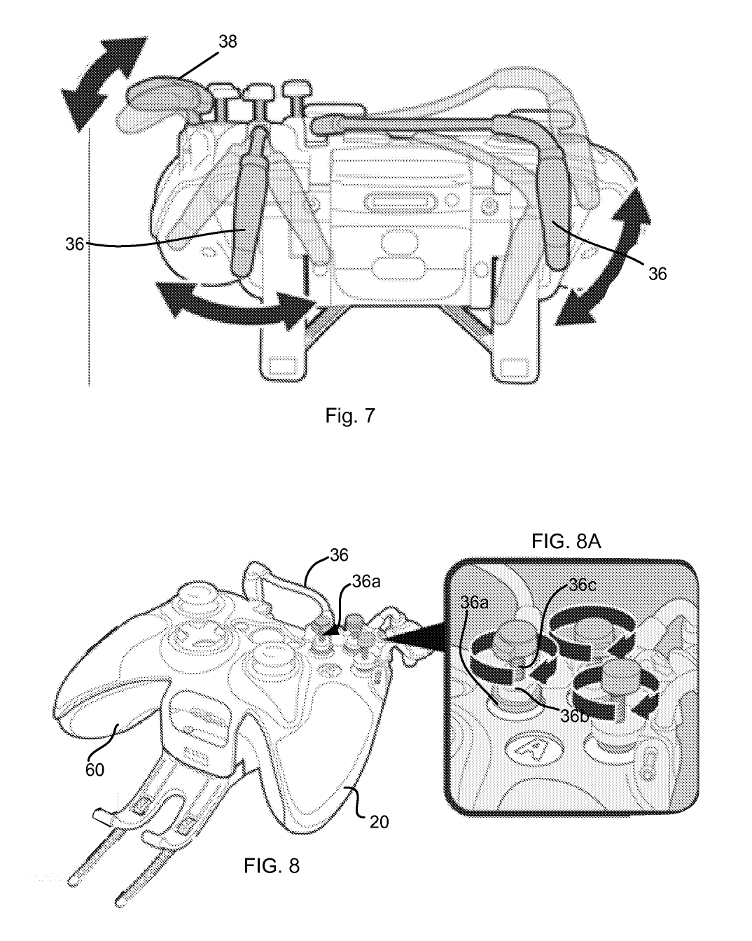

Referring now to FIGS. 7, 8 and 8A, it can be seen that, in addition to adjusting the tension of the straps 50 or lines 55, the levers 36, 38 and other actuators on the game controller skin 20 can also be adjusted to a particular user. For example, as shown in FIG. 7, the levers 36, 38 may be bent up, down, forward and/or backward to more comfortably fit the hand of the user. This is a way for the user to remap the buttons non-electronically.

Additionally, as shown more particularly in FIGS. 8 and 8A, the amount of force needed to actuate the buttons contacted by the levers 36, 28 can be adjusted. More particularly, Each of the levers 36, 38 is aligned over one of the buttons “B”, “X” and “Y” of the controller 60. More particularly, each of the levers 36, 38 includes a pad, such as pad 36a, that is mounted to an arm of the lever via a finger, such as finger 36b, by an adjustment screw, such as thumb screw 36c. The screw 36c can be adjusted to “fine-tune” the height of the pad 31a over the actual button, for example, button “B” of the underlying controller, in order to set to a user's preferences the amount of lift of the lever 36 required to depress the button “B”.

Thus, like the straps 50 and lines 55, the screw 36c is used to take all of the preload out of the levers 36, 38 relative to the underlying buttons “B”, “X”, “Y”. This permits the buttons to be actuated faster and with less effort. In one particularly embodiment of the invention, the screws 36c are adjusted until the controller activates, and then the screw is backed off by % turn to set an ideal pad height. If desired, a spring could be disposed coaxially around the screws 36c, between the finger 36b and the pad 36a, to further spring load/preload the levers 36, 38.

In another embodiment of the invention, the control buttons on the controllers are additionally provided with different functional enhancements. For example, stick-ons of any type of material can be adhered to the pads 36a to enhance performance. Materials such as rubber or springs can be stuck on to the pad 36a, to affect performance and/or how the buttons click. Other enhancements to the controller can be made, for example, by adding a material to the buttons/controller switches that slows down their movement.

Further, game enhancing features can be provided to coordinate actuation of the enhanced buttons with game play. For example, in one particular embodiment of the invention, a little switch can be provided on the controller skin that is actuated to enhance the game sounds, such as for stabbing in games like HALO or Call of Duty. Such sounds can be adapted to a particular game, for example, the switch can be actuated in a certain game to have an extra clicking if you lift x for reloading or, for example, when switching weapons you have an extra wind sound. In another particular example, you lift the “B” lever and you have a little grunting when getting down on the ground and/or when getting up. To enact such game enhancements, a controller accessory can be provided that includes a sound card to make noise upon actuation. It all comes from the avenger like a card that makes noise.

In an even further embodiment of the invention, the levers of a game controller accessory are adapted to permit reverse gearing of the levers, as shown more particularly in FIG. 19.

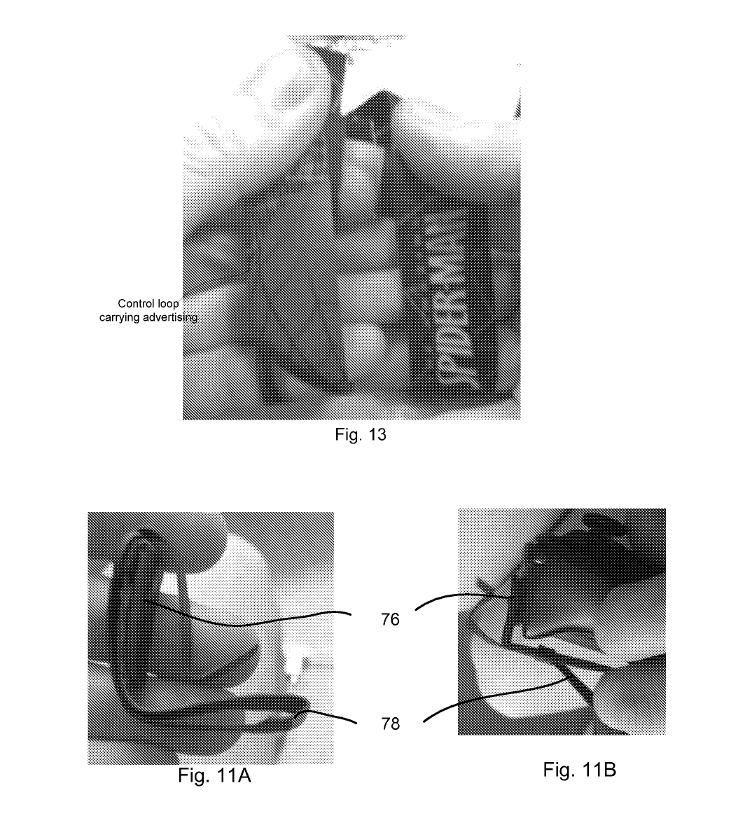

Additionally, if desired, the material of the control loops and/or the material covering the grips of the game controller can be used to display advertising, like a billboard. See, for example, FIGS. 12-13. Such advertising could be for a particular game, for example a game with which such straps could be used (i.e., Halo, etc.), or could be just an advertisement for another type of product, service and/or media event.

The present disclosure is provided to allow practice of the invention, after the expiration of any patent granted hereon, by those skilled in the art without undue experimentation, and includes the best mode presently contemplated and the presently preferred embodiment. Nothing in this disclosure is to be taken to limit the scope of the invention, which is susceptible to numerous alterations, equivalents and substitutions without departing from the scope and spirit of the invention.

We claim:

1. An accessory for a game controller, comprising:
a strap connected to apply a force to an actuator on the game controller.

2. The accessory of claim 1, wherein the strap is removably attached directly to the actuator.

3. The accessory of claim 1, further including a lever aligned over the actuator, said strap being attached to said lever.

4. The accessory of claim 3, wherein said strap is arranged so that an external force applied to said strap in a first direction causes said lever to actuate said actuator.

5. The accessory of claim 3, wherein said strap is configured as a control loop.

6. The accessory of claim 3, further including a stand portion attached distal from said lever.

7. The accessory of claim 6, wherein said strap is connected between said lever and said stand.

8. The accessory of claim 7, wherein said strap is a flexible elastic line.

9. The accessory of claim 7, wherein said strap is an adjustable tension strap including a plurality of projections on a surface of the strap.

10. The accessory of claim 9, wherein the stand includes a tongue portion that engages at least one of said plurality of projections to maintain the strap taught with the lever preloaded against the actuator.

11. The accessory of claim 1, further including a plurality of straps, wherein the game controller includes a plurality of actuators and the accessory includes a plurality of levers, one lever of said plurality of levers disposed proximal to one actuator of said plurality of actuators, each lever of said plurality of levers being connected to one strap of said plurality of straps.

12. An accessory for a game controller including at least one actuator, the accessory comprising:
a shell including a top portion and a bottom portion, the top portion and bottom portion engageable to receive the game controller inside said shell, between said top portion and said bottom portion;
said shell further including at least one lever, a portion of said lever being arranged proximal to the actuator on the game controller;
a stand attached to said bottom portion of said shell, distal from said lever; and
a strap connected between said lever and said stand.

13. The accessory of claim 12, wherein the strap is removably attached to said stand.

14. The accessory of claim 12, wherein said strap is arranged so that an external force applied to said strap in a first direction causes said lever to actuate said actuator.

15. The accessory of claim 12, wherein said strap is a flexible elastic line.

16. The accessory of claim 15, wherein said flexible line is configured to be taut with said lever preloaded against said stand.

17. The accessory of claim 12, wherein said strap is an adjustable tension strap including a plurality of projections on a surface of the strap.

18. The accessory of claim 17, wherein the stand includes a tongue portion that engages at least one of said plurality of projections to maintain the strap taut with the lever preloaded against the actuator.

19. A method of using an accessory for a game controller including at least one actuator, comprising the steps of:
providing the accessory of claim 12;
separating at least a portion of the top portion from the bottom portion to open the shell;
placing the game controller between the top portion and the bottom portion and engaging the top portion with the bottom portion to enclose the game controller therein with the at least one actuator aligned with a portion of the lever; and
adjusting the tension of the strap to preload the lever against the actuator.

20. The method of claim 19, wherein said strap is a flexible elastic line.
